(19) United States
(12) Patent Application Publication
(10) Pub. No.: US 2004/0247287 A1
(43) Pub. Date: Dec. 9, 2004

(54) Video signal output device and video signal output method

(75) Inventor: Akira Miyazawa, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/793,214

(22) Filed: Mar. 5, 2004

(30) Foreign Application Priority Data
Jun. 3, 2003 (JP) 2003-158330

(51) Int. Cl. H04N 5/76; G06F 3/00; H04N 5/445; G06F 13/00; H04N 5/91

(52) U.S. Cl. 386/83; 725/58

(57) ABSTRACT

A video signal output device including a video output terminal which is to be connected to a recording apparatus to output a video signal to the recording apparatus via the video output terminal, the device comprising a broadcasting reception unit configured to receive broadcasting, a record reservation setting unit configured to set record reservation with respect to the broadcasting received by the broadcasting reception unit, a video signal generation unit configured to produce the video signal from the broadcasting received by the broadcasting reception unit, and a control unit configured to output the video signal generated by the video signal generation unit to the video output terminal based on a start time of the reserved recording and to stop the output to the video output terminal based on an end time of the reserved recording.

### CROSS-REFERENCE TO RELATED APPLICATIONS

This application is based upon and claims the benefit of priority from prior Japanese Patent Application No. 2003-158330, filed Jun. 3, 2003, the entire contents of which are incorporated herein by reference.

### BACKGROUND OF THE INVENTION

1. Field of the Invention

The present invention relates to a video signal output device and a video signal output method in which a video signal obtained, for example, by receiving a satellite digital broadcasting or the like is outputted to a recording/reproducing apparatus connected to the outside.

2. Description of the Related Art

As is well known, in recent years, digitization of television broadcasting has been promoted. Moreover, in Japan, progresses have been made to start not only satellite digital broadcastings such as broadcasting satellite (BS) digital broadcasting and 110-degrees communication satellite (CS) digital broadcasting but also terrestrial digital broadcasting.

Moreover, even for recording apparatuses for recording/reproducing video signals with respect to recording mediums, at present, apparatuses on which not only a tuner for the terrestrial analog broadcasting but also a tuner for BS digital broadcasting or 110-degrees CS digital broadcasting are mounted have been put on the market.

Additionally, there have bee still only a small number of recording apparatuses on which the tuners for the digital broadcasting are mounted, and there have been a larger number of recording apparatuses on which the tuners for the digital broadcasting are not mounted in the present situations.

Therefore, to record a digital broadcasting program in the recording apparatus which is not adapted for the digital broadcasting, a digital broadcasting receiver is connected to the recording apparatus, and an analog video signal outputted from a video output terminal of the digital broadcasting receiver is supplied to a video input terminal of the recording apparatus and recorded.

Additionally, when video recording is reserved in this video recording means, reservation setting of a desired program is performed with respect to the digital broadcasting receiver. Since it is also necessary to set the video record reservation with respect to the recording apparatus in accordance with the program reservation set in the digital broadcasting receiver, there is a problem that an operation for the video record reservation becomes much complicated.

Moreover, to solve the problem, a recording apparatus has also been developed having a function of automatically starting the recording of the signal supplied to the video input terminal (input automatic recording function) at a time when a synchronous signal of the video signal is detected from the signal supplied to the video input terminal.

Since the apparatus has this function, a user sets the reservation of the desired program only with respect to the digital broadcasting receiver, and simply sets the recording apparatus to an input automatic recording function mode, so that the record reservation operation can be completed and the operation for the record reservation can be simplified.

However, the recording operation by this input automatic recording function is controlled by judging whether or not the video signal is outputted from the digital broadcasting receiver. When the user sees/hears a program in a time slot different from that of the reserved program in a state in which the reservation of the program is set to the digital broadcasting receiver and the recording apparatus is set to the input automatic recording function mode, a problem occurs that the recording apparatus is driven by the video signal of the seen/heard program.

In Jpn. Pat. Appln. KOKAI Publication No. 2001-357615, a constitution is described in which a broadcasting date, channel, broadcasting time (recording time) and the like indicated by reservation information are recorded in a reserved recording table beforehand, and it is judged whether or not the program scheduled to be automatically recorded, whose broadcasting date and recording time overlap with those recorded in the reserved recording table, is recorded in an automatic recording table.

Moreover, in Jpn. Pat. Appln. KOKAI Publication No. 2001-257974, a constitution is described in which various program information added to a broadcasting signal can be used to set timer record reservation, and accordingly the timer record reservation for repeatedly and continuously recording the same program can securely be performed with a simple operation.

Furthermore, in Jpn. Pat. Appln. KOKAI Publication No. 2003-110982, a constitution is described in which a program to be broadcasted is reserved and recorded in random accessible recording mediums such as a hard disk.

However, in any of these publications, the solving of various problems caused in connecting the recording apparatus to the digital broadcasting receiver to record the video as described above is not described.

### BRIEF SUMMARY OF THE INVENTION

According to one aspect of the present invention, there is provided a video signal output device including a video output terminal which is to be connected to a recording apparatus to output a video signal to the recording apparatus via the video output terminal, the device comprising: a broadcasting reception unit configured to receive broadcasting; a record reservation setting unit configured to set record reservation with respect to the broadcasting received by the broadcasting reception unit; a video signal generation unit configured to produce the video signal from the broadcasting received by the broadcasting reception unit; and a control unit configured to output the video signal generated by the video signal generation unit to the video output terminal based on a start time of the reserved recording and to stop the output to the video output terminal based on an end time of the reserved recording.

According to another aspect of the present invention, there is provided a video signal output method in which a video signal is outputted to a recording apparatus via a video output terminal, comprising: receiving broadcasting; setting record reservation with respect to the received broadcasting; generating the video signal from the received broadcasting; and outputting the generated video signal to the video output terminal based on a start time of the reserved recording and stopping the output to the video output terminal based on an end time of the reserved recording.

### BRIEF DESCRIPTION OF THE SEVERAL VIEWS OF THE DRAWING

FIG. 1 is a block diagram showing a system for receiving and recording BS digital broadcasting according to one embodiment of the present invention;

FIG. 2 is a block diagram showing a signal processing system of a digital television receiver in the embodiment;

FIG. 3 is a flowchart showing a setting operation of reservation by date designation in the digital television receiver;

FIG. 4 is an explanatory view of one example of a channel setting screen in the reservation setting operation;

FIG. 5 is an explanatory view of one example of a start/end time setting screen in the reservation setting operation;

FIG. 6 is an explanatory view of one example of a reservation selection screen in the reservation setting operation;

FIG. 7 is an explanatory view of one example of a record reservation setting screen in the reservation setting operation;

FIG. 8 is an explanatory view of one example of a mode changeover screen in the digital television receiver;

FIG. 9 is a flowchart showing a recording operation based on the record reservation in the digital television receiver;

FIG. 10 is a timing chart showing the recording operation based on the record reservation in the digital television receiver;

FIG. 11 is a flowchart showing the setting operation of reservation by program designation in the digital television receiver;

FIG. 12 is an explanatory view of one example of a program selection screen in the reservation setting operation;

FIG. 13 is an explanatory view of one example of the reservation selection screen in the reservation setting operation;

FIG. 14 is an explanatory view of one example of the record reservation setting screen in the reservation setting operation;

FIG. 15 is a timing chart showing a detailed recording operation based on the record reservation in the digital television receiver;

FIG. 16 is an explanatory view of one example of a recording apparatus type selection screen in the recording operation;

FIG. 17 is a flowchart showing an operation in performing a program recording request during the seeing/hearing in the digital television receiver;

FIG. 18 is an explanatory view of one example of a recording setting screen in the program recording request operation;

FIG. 19 is a flowchart showing the recording operation based on the program recording request during the seeing/hearing in the digital television receiver;

FIG. 20 is a timing chart showing the recording operation based on the program recording request during the seeing/hearing in the digital television receiver;

FIG. 21 is a block diagram showing a modification of the embodiment;

FIG. 22 is a block diagram showing another modification of the embodiment; and

FIG. 23 is a block diagram showing still another modification of the embodiment.

### DETAILED DESCRIPTION OF THE INVENTION

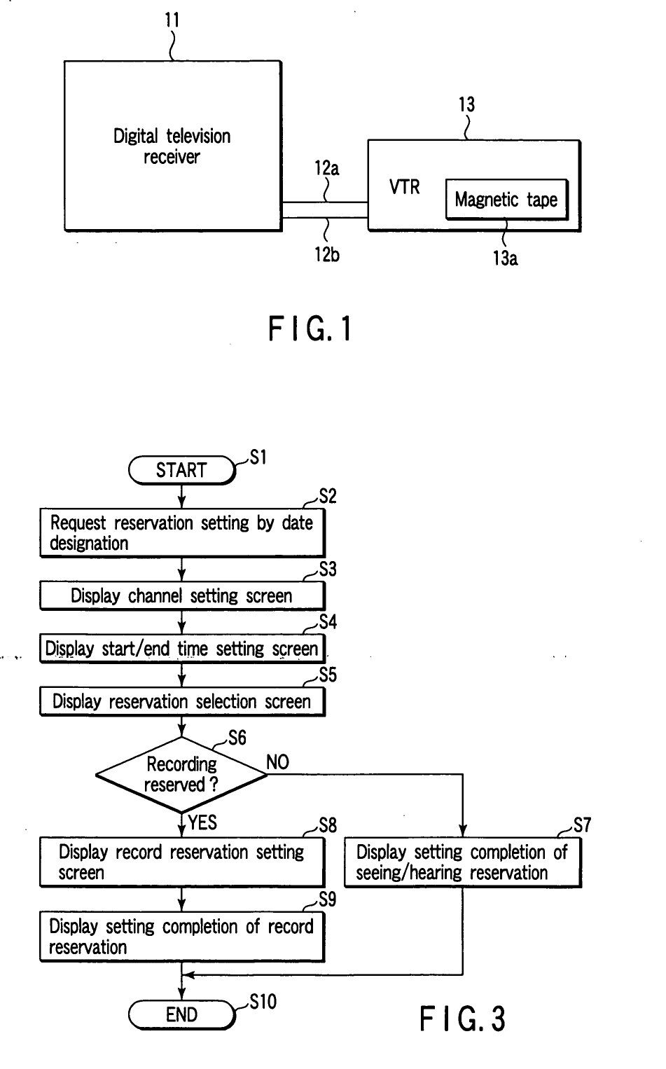

One embodiment of the present invention will hereinafter be described in detail with reference to the drawing. FIG. 1 schematically shows a system for receiving and recording BS digital broadcasting described in the present embodiment.

That is, in FIG. 1, reference numeral 11 denotes a digital television receiver which receives the BS digital broadcasting. The digital television receiver 11 selects a desired program from the received BS digital broadcasting and produces analog video and audio signals corresponding to the selected program to display video and to reproduce audio.

Moreover, the digital television receiver 11 is capable of outputting the produced analog video and audio signals to a video tape recorder (VTR) 13 which is a recording apparatus via cables 12a, 12b to record the signals in a magnetic tape 13a. It is to be noted that an input automatic recording function is mounted on the VTR 13.

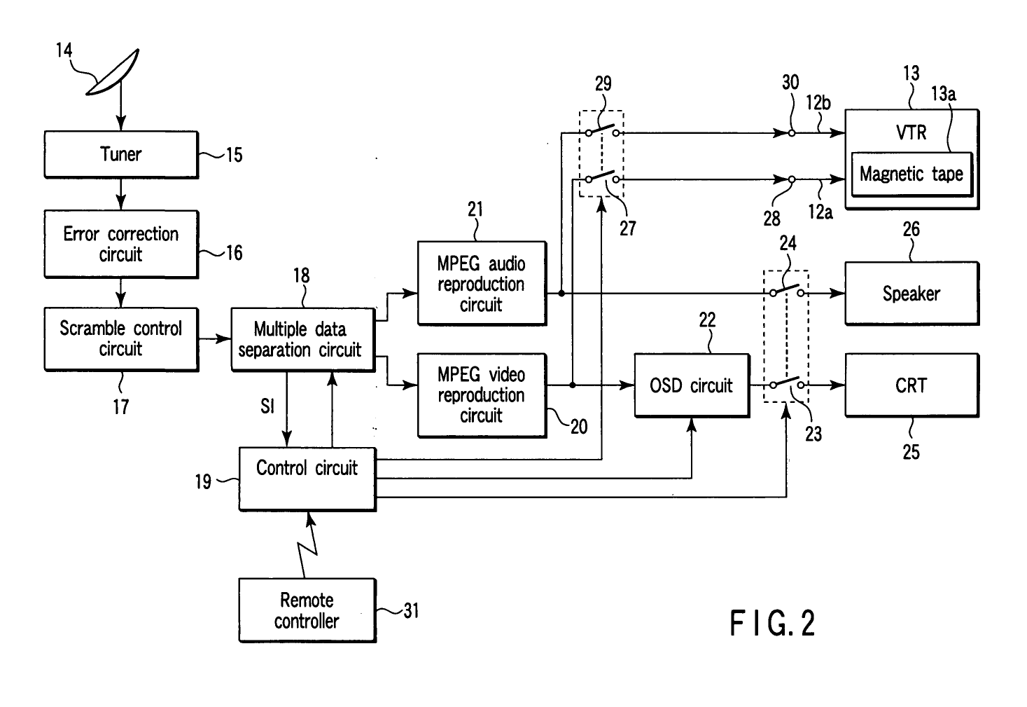

FIG. 2 shows a signal processing system of the digital television receiver 11. That is, a BS digital broadcasting signal received via a satellite antenna 14 is supplied to a tuner 15 to select a predetermined transmission channel, and is thereafter outputted to an error correction circuit 16.

The error correction circuit 16 subjects the received signal outputted from the tuner 15 to demodulation processing and error correction processing, and thereafter outputs the signal to a scramble control circuit 17.

When the inputted received signal is subjected to scramble processing, the scramble control circuit 17 subjects the signal to descramble processing to release the scramble, and outputs the signal to a multiple data separation circuit 18. In this case, data supplied to the multiple data separation circuit 18 from the scramble control circuit 17 is multiple data including data of a plurality of channels and programs.

The multiple data separation circuit 18 separates a packet based on identification information ID included in a bit stream of the received signal. Moreover, the multiple data separation circuit 18 separates program information of service information (SI), then supplies these program information to a control circuit 19, further supplies a video signal for each packet to a moving picture experts group (MPEG) video reproduction circuit 20, and supplies the audio signal to an MPEG audio reproduction circuit 21.

For the MPEG video reproduction circuit 20, Since the inputted video signal is compressed/coded, compressed/coded data is subjected to decode processing, and an analog video signal is restored and outputted to an on screen display (OSD) circuit 22.

Moreover, the control circuit 19 produces an OSD signal required on the display based on SI information acquired from the multiple data separation circuit 18, and outputs the signal to the OSD circuit 22.

Furthermore, the OSD circuit 22 superimposes the video signal supplied from the MPEG video reproduction circuit 20 upon the OSD signal supplied from the control circuit 19, and outputs the signals to a switch 23.

Additionally, since the inputted audio signal is compressed/coded, the MPEG audio reproduction circuit 21 subjects the audio signal to the decode processing, and outputs the decoded/processed analog audio signal to a switch 24.

These switches 23, 24 cooperate with each other and are changed into an on-state or off-state based on the control of the control circuit 19. Moreover, when the switches 23, 24 are changed to the on-state, the video signal outputted from the OSD circuit 22 is supplied to a cathode ray tube (CRT) 25 to display video, and the audio signal outputted from the MPEG audio reproduction circuit 21 is supplied to a speaker 26 to reproduce audio.

Moreover, when the switches 23, 24 are changed to the off-state, the video signal is outputted from the OSD circuit 22, and audio signal is outputted from the MPEG audio reproduction circuit 21, but the video display by the CRT 25 and the audio reproduction by the speaker 26 are not carried out, and a standby state can be realized in this manner.

Here, the video signal outputted from the MPEG video reproduction circuit 20 is supplied to a video output terminal 28 for recording via a switch 27. The audio signal outputted from the MPEG audio reproduction circuit 21 is supplied to an audio output terminal 30 for recording via a switch 29.

These switches 27, 29 cooperate with each other and are changed into the on-state or off-state based on the control of the control circuit 19. Moreover, the video output terminal 28 and audio output terminal 30 are connected to the video and audio input terminals of the VTR 13 via the cables 12a, 12b.

Accordingly, the video signal and the audio signal outputted from the MPEG video reproduction circuit 20 and the MPEG audio reproduction circuit 21 can be controlled so as to be or not to be supplied to the VTR 13 regardless of the seeing/hearing by the CRT 25 and speaker 26.

Moreover, when the switches 27, 29 are changed to the on-state, and the video signal and audio signal outputted from the MPEG video reproduction circuit 20 and MPEG audio reproduction circuit 21 are supplied to the VTR 13, the VTR 13 detects a synchronous signal from the inputted video signal to automatically start the recording of the video and audio signals.

Here, all the operations of the digital television receiver 11 are generally controlled by the control circuit 19. The control circuit 19 includes a central processing unit (CPU) (not shown), and controls each circuit portion so as to receive operation information sent from a remote controller 31 so that operation contents are reflected.

FIG. 3 shows a setting operation of reservation by designation of date in the digital television receiver 11. First, when a process is started (step S1), in step S2 a user operates the remote controller 31 to request reservation setting by date designation.

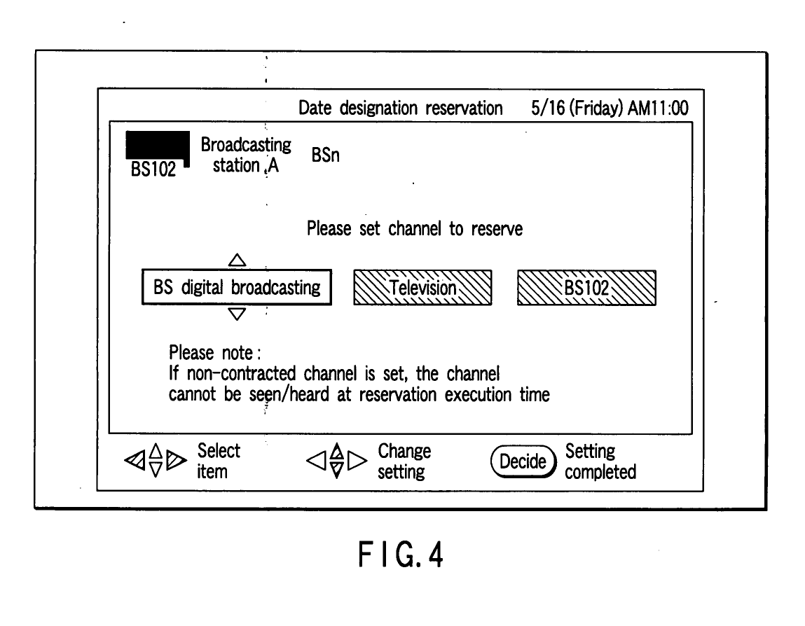

Then, the control circuit 19 allows the CRT 25 to display a channel setting screen in step S3. As shown in FIG. 4, a plurality of items regarding the channel are displayed on the channel setting screen. Moreover, the user operates the remote controller 31 to select and decide the channel to reserve from the displayed items with a cursor.

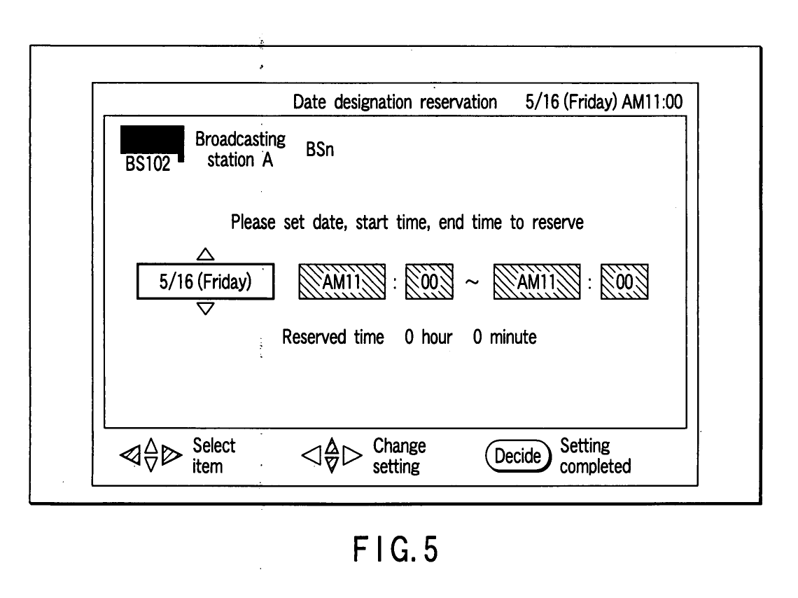

When the setting of the channel is completed, the control circuit 19 allows the CRT 25 to display a start/end time setting screen in step S4. In this start/end time setting screen, as shown in FIG. 5, items such as date, start time and end time to reserve are displayed. Subsequently, the user operates the remote controller 31 to input each item.

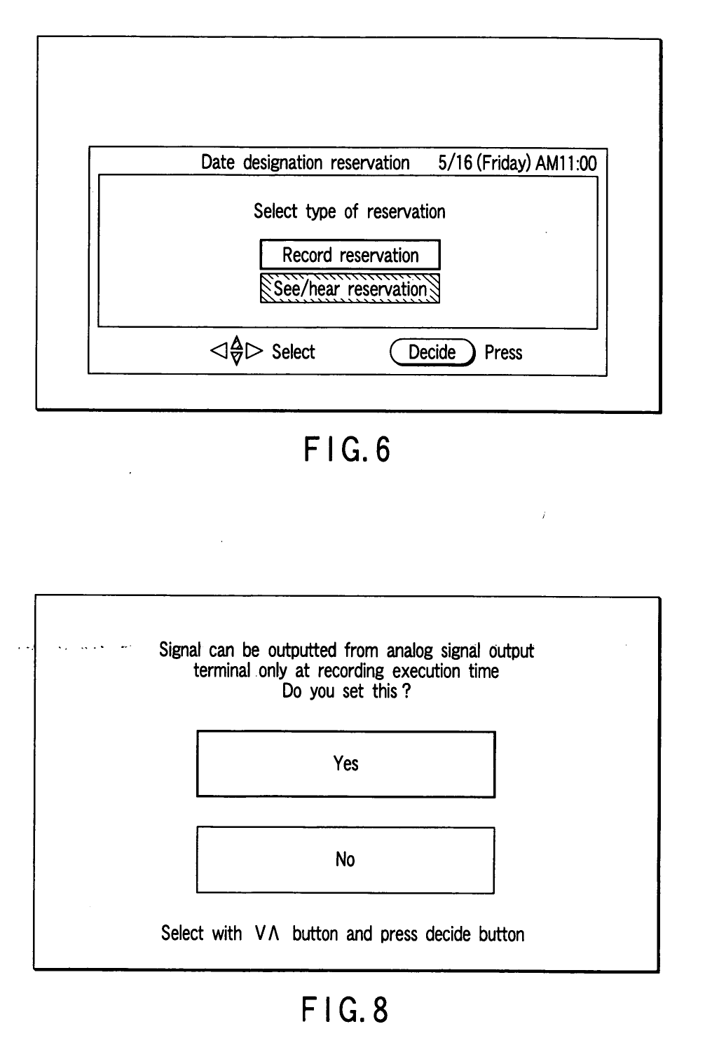

Thereafter, the control circuit 19 allows the CRT 25 to display a reservation selection screen in step S5. In the reservation selection screen, as shown in FIG. 6, an item indicating record reservation or see/hear reservation is displayed. Subsequently, the user operates the remote controller 31 to select and decide a desired reservation mode from the displayed item with the cursor.

Subsequently, the control circuit 19 judges whether or not the record reservation is selected in step S6, judges the see/hear reservation in a case where the record reservation is judged not to be selected (NO), and allows the CRT 25 to display that the setting of the see/hear reservation has been completed in step S7 to end the process (step S10).

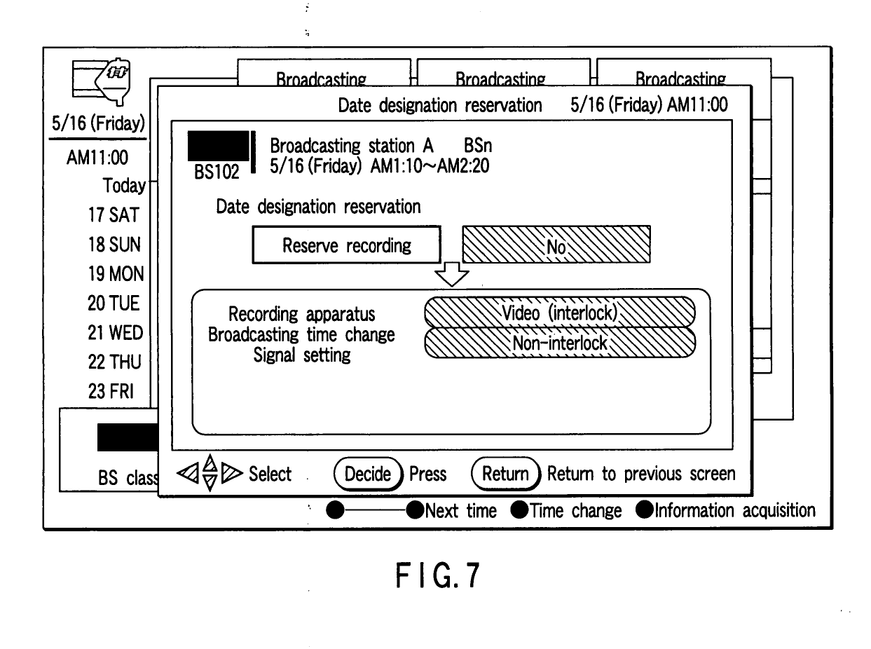

Moreover, when the record reservation is judged to be selected in the step S6 (YES), the control circuit 19 allows the CRT 25 to display a record reservation setting screen in step S8. In the record reservation setting screen, as shown in FIG. 7, various items required for the recording, such as an item for selecting whether or not to reserve the recording and an item for designating an apparatus to perform the recording, are displayed.

Subsequently, the user operates the remote controller 31 to input necessary items of the record reservation setting screen. Then, the control circuit 19 allows the CRT 25 to display that the setting of the record reservation has been completed in step S9 to end the process (step S10).

Moreover, in the digital television receiver 11, it is possible to change a constant output mode in which the switches 27, 29 are constantly brought into the on-state to output the analog video and audio signals to the outside from the video output terminal 28 and audio output terminal 30, and a recording output mode in which the switches 27, 29 are brought into the on-state only at a recording execution time to output the analog video and audio signals to the outside from the video output terminal 28 and audio output terminal 30.

This mode changeover is carried out, when the user operates the remote controller 31 to request a mode changeover. When the mode changeover is requested, the control circuit 19 allows the CRT 25 to display a mode changeover screen.

In the mode changeover screen, as shown in FIG. 8, a setting to output the signal from the analog signal output terminal (i.e., the video output terminal 28 and audio output terminal 30) only at the recording execution time, that is, an item indicating whether or not to set the recording output mode is displayed.

Subsequently, the user operates the remote controller 31 to select and decide a desired item with the cursor, so that the constant output mode and the recording output mode can be switched.

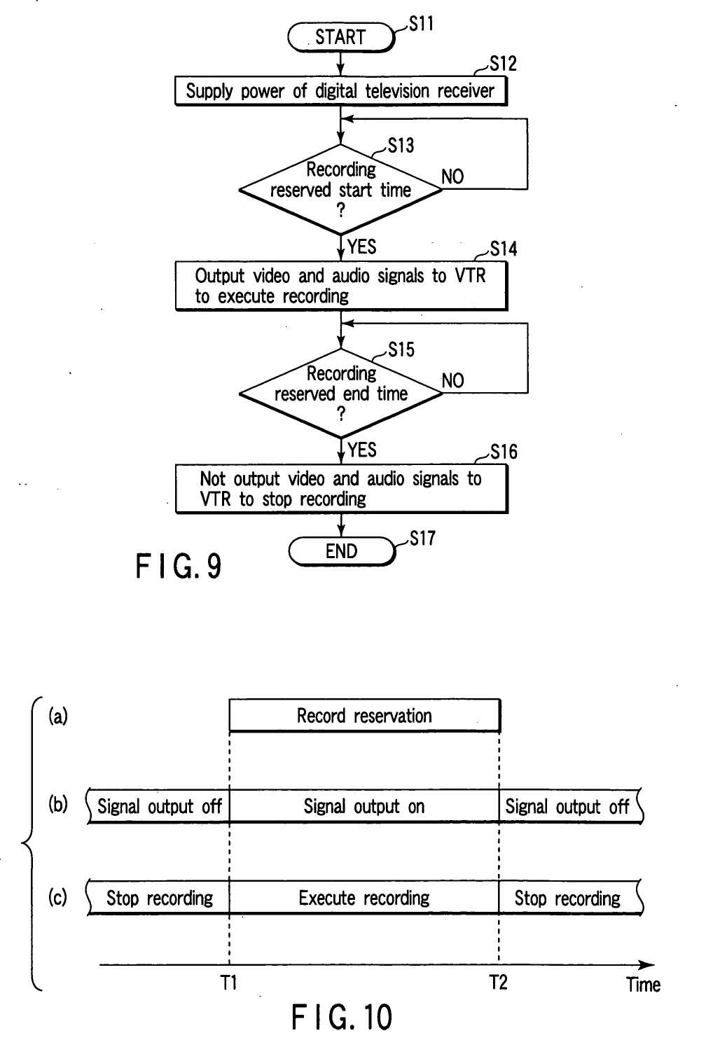

FIG. 9 shows an operation in a case where the record reservation by date designation is set and the recording output mode is set with respect to the digital television receiver 11. First, the process is started (step S11), and the user turns power on in the digital television receiver 11 in step S12.

Then, the control circuit 19 controls each circuit unit in a reception state, and the received program video and audio signals are supplied to the CRT 25 and speaker 26 to be seen/heard.

At this time, when it is not a recording reserved start time yet, the control circuit 19 controls the switches 27, 29 in the off-state, and prevents the recording from being performed without supplying the video and audio signals to the VTR 13.

In this reception state, the control circuit 19 judges whether or not it is the recording reserved start time in step S13. When it is judged to be the time (YES), the switches 27, 29 are controlled in the on-state in step S14, and the video and audio signals are supplied to the VTR 13 so that the recording is controlled to be executed.

In this recording state, the control circuit 19 judges whether or not it is a recording reserved end time in step S15. When it is judged to be the time (YES), the switches 27, 29 are controlled in the off-state in step S16, and the video and audio signals are prevented from being supplied to the VTR 13 to stop the VTR 13. Here, the recording operation by the record reservation is ended (step S17).

FIG. 10 is a timing chart showing the recording operation on a digital television receiver 11 and that on a VTR 13 by the record reservation. In FIG. 10, (a) shows a recording reserved time slot, (b) shows the operation of the digital television receiver 11, and (c) shows the operation of the VTR 13.

First, as shown in FIG. 10(a), it is assumed that the recording reserved start time is T1, the recording reserved end time is T2 and the record reservation is set. In this case, at or before time T1, as shown in FIG. 10(b), for the digital television receiver 11, the switches 27, 29 are changed to the off-state, and the video and audio output terminals 28, 30 are controlled not to output the video and audio signals. Therefore, at or before the time T1, as shown in FIG. 10(c), since the video signal is not supplied, the VTR 13 does not perform the recording operation, and is controlled in a recording stop state.

It is to be noted that in the state at or before the time T1, the digital television receiver 11 receives the broadcasting of an optional channel, and the video and audio signals can be received via the CRT 25 and speaker 26 to see/hear the program.

Subsequently, at the recording reserved start time T1, as shown in FIG. 10(b), for the digital television receiver 11, the switches 27, 29 are changed in the on-state, and the video and audio signals of the recording-reserved channel are outputted from the video and audio output terminals 28, 30. Therefore, at and after time T1, as shown in FIG. 10(c), for the VTR 13, since the video signal is supplied and the synchronous signal is detected, a recording execution state is controlled by an input automatic recording function.

It is to be noted that at the recording reserved start time T1, the video and audio signals can be received via the CRT 25 and speaker 26 to see/hear the recording-reserved channel.

Thereafter, at the recording reserved end time T2, as shown in FIG. 10(b), in the digital television receiver 11, the switches 27, 29 are changed in the off-state, and the video and audio signals are controlled not to be outputted from the video and audio output terminals 28, 30. Therefore, at and after the time T2, as shown in FIG. 10(c), since the video signal is not supplied, the VTR 13 does not perform the recording operation, and is controlled in a recording stop state.

In accordance with the above-described embodiment, only at the recording execution time by the set record reservation, the switches 27, 29 are brought into the on-state, and the analog video and audio signals are outputted to the VTR 13 from the video and audio output terminals 28, 30 to perform the recording.

Therefore, even when the digital television receiver 11 is switched on and brought into the reception state, there is not a disadvantage that the video and audio signals of the received program are unconditionally outputted to the VTR 13, and it is possible to perform the recording operation suitable for the practical use.

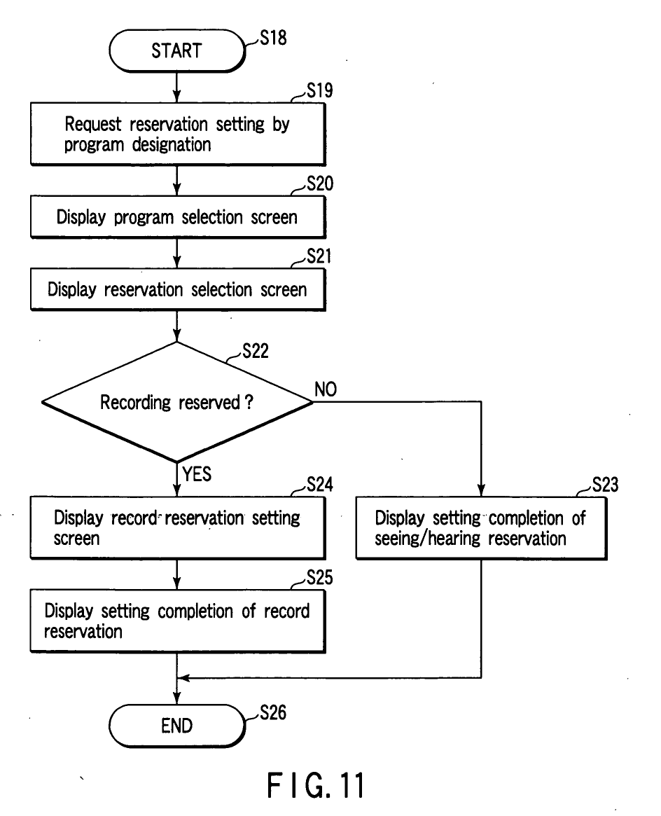

FIG. 11 shows the setting operation of reservation by the designation of the program in the digital television receiver 11. First, when the process is started (step S18), the user operates the remote controller 31 to request the reservation setting by the program designation in step S19.

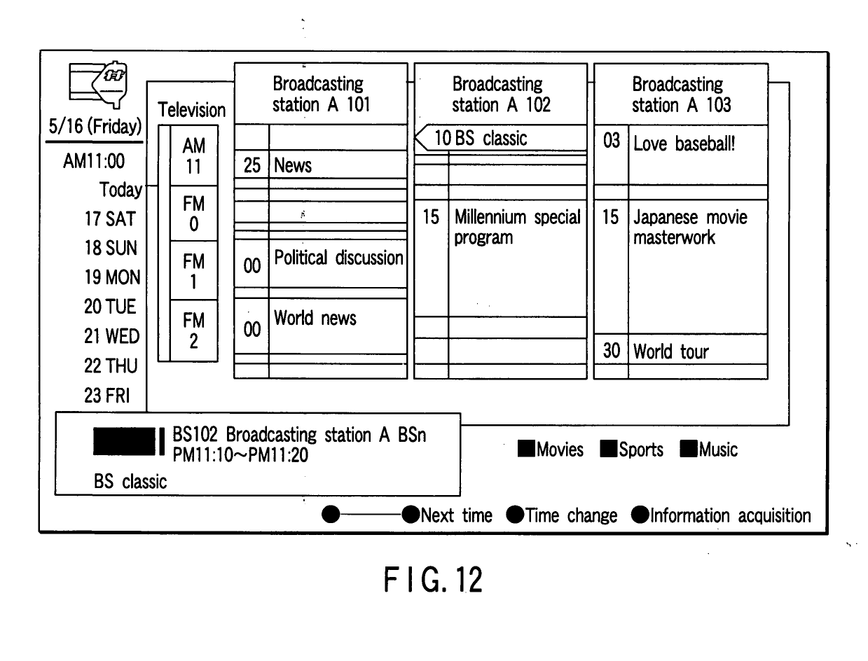

Then, the control circuit 19 allows the CRT 25 to display a program selection screen in step S20. In the program selection screen, as shown in FIG. 12, a program list based on SI information is displayed. Subsequently, the user operates the remote controller 31 to select and decide the program to be reserved from the program list.

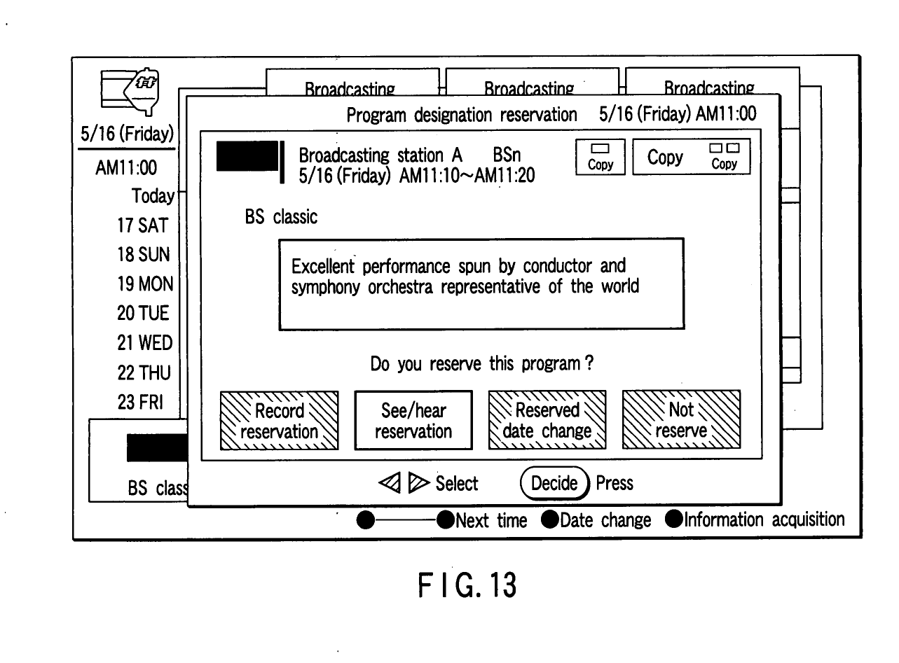

Thereafter, the control circuit 19 allows the CRT 25 to display a reservation selection screen in step S21. In this reservation selection screen, as shown in FIG. 13, the item indicating the record reservation or the see/hear reservation is displayed. Subsequently, the user operates the remote controller 31 to select and decide a desired reservation mode from the displayed items with the cursor.

Subsequently, the control circuit 19 judges whether or not the record reservation is selected in step S22. When it is judged that the record reservation is not selected (NO), the see/hear reservation is judged, the CRT 25 is allowed to display that the setting of the see/hear reservation has been completed in step S23, and the process is ended (step S26).

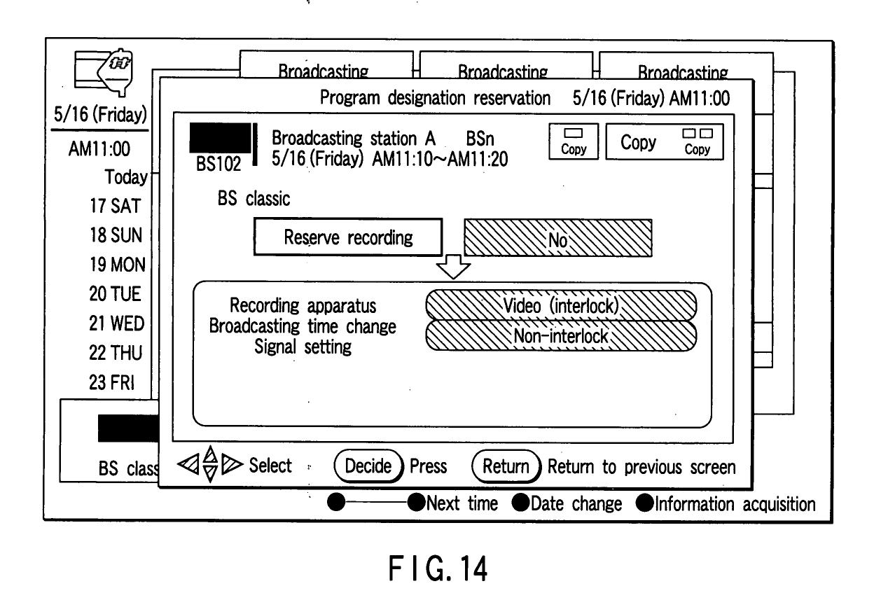

Moreover, when it is judged in step S22 that the record reservation is selected (YES), the control circuit 19 allows the CRT 25 to display the record reservation setting screen in step S24. In this record reservation setting screen, as shown in FIG. 14, an item selecting whether or not to reserve the recording, an item designating the apparatus to record, and various items required for the recording are displayed.

Subsequently, when the user operates the remote controller 31 to input the necessary items of the record reservation setting screen, the control circuit 19 allows the CRT 25 to display that the setting of the record reservation has been completed in step S25 to end the process (step S26).

Even in the state in which the record reservation by the program designation is set, needless to say, the digital television receiver 11 is capable of practically performing the recording operation described above with reference to FIG. 9.

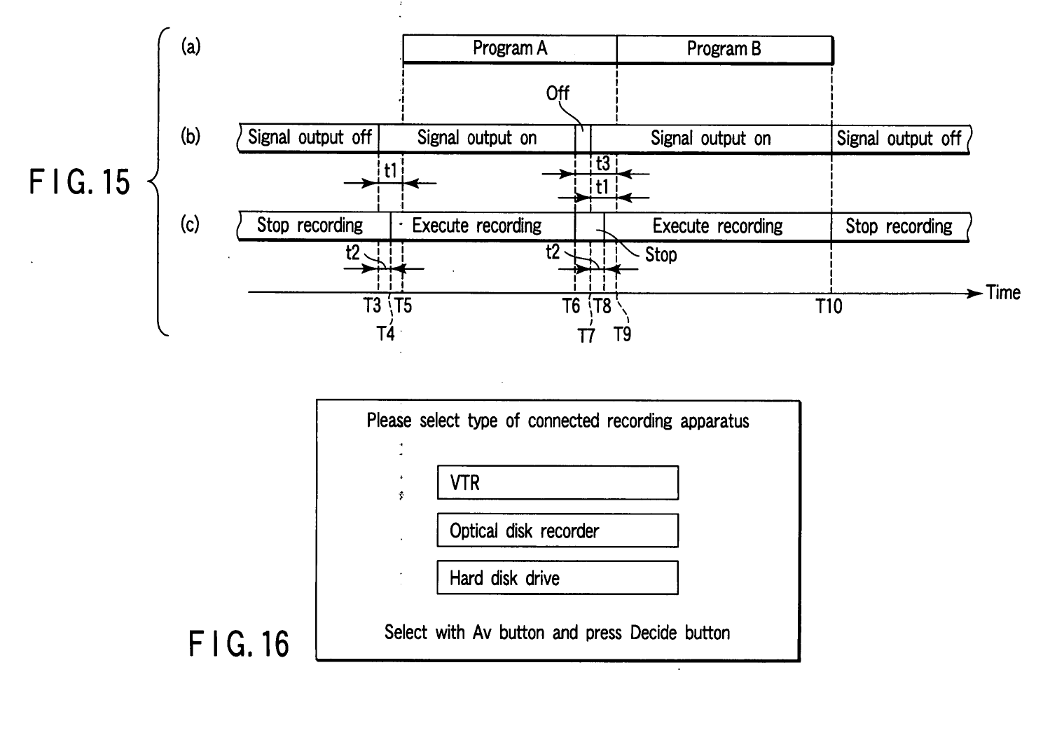

FIG. 15 is a timing chart showing the recording operation on the digital television receiver 11 and that on the VTR 13 by the record reservation in more detail. In FIG. 15, (a) shows a recording reserved program, (b) shows the operation of the digital television receiver 11, and (c) shows the operation of the VTR 13.

First, the operation at the start time of the reserved recording. That is, as shown in FIG. 15(a), at or before a recording reserved start time T5 of a recording reserved program A, as shown in FIG. 15(b), the switches 27, 29 of the digital television receiver 11 are changed into the off-state, and the video and audio output terminals 28, 30 are controlled not to output the video and audio signals. Therefore, at or before the time T5, as shown in FIG. 15(c), since the video signal is not supplied, the VTR 13 does not perform the recording operation, and is controlled in a recording stop state.

Moreover, at a time T3 earlier than the recording reserved start time T5 by a preset time t1, as shown in FIG. 15(b), the switches 27, 29 of the digital television receiver 11 are changed into the on-state, and the video and audio signals of the recording reserved channel are outputted from the video and audio output terminals 28, 30.

Thereafter, at a time T4 after an elapse of a predetermined time t2 from the time T3 and before the recording reserved start time T5, as shown in FIG. 15(c), since the video signal is supplied and the synchronous signal is detected, the VTR 13 is controlled in the recording execution state by the input automatic recording function, a stable recording operation state is achieved at time T5 and the recording reserved program A is recorded.

In this manner, at the time T3 earlier than the recording reserved start time T5 by the predetermined time t1, the digital television receiver 11 outputs the video and audio signals. Accordingly, actually at the recording reserved start time T5, the VTR 13 which has been in the recording stop state is in the stable recording operation state, and it is possible to perform highly reliable recording.

Here, a time by which the time T3 for outputting the video and audio signals from the digital television receiver 11 is earlier than the recording reserved start time T5 differs with the connected recording apparatus. That is, a time from when the video and audio signals are supplied until the stable recording operation state is achieved differs with the recording apparatus.

Therefore, by the operation of the remote controller 31, the CRT 25 may be allowed to display a recording apparatus type selection screen, and the type of the presently connected recording apparatus may also be inputted. In this recording apparatus type selection screen, as shown in FIG. 16, items indicating the types of the recording apparatus such as VTR, optical disk recorder and hard disk drive are displayed.

Subsequently, the user operates the remote controller 31 to select and decide the type of the presently connected recording apparatus from the displayed items with the cursor. Accordingly, the control circuit 19 is capable of setting the time t1 in accordance with the type of the connected recording apparatus.

Next, a case where programs A, B continued in time are respectively record-reserved will be described. Here, a case where a recording reserved end time T9 of the program A agrees with the recording reserved start time of the program B will be described, but a similar operation is performed even in a case where the recording reserved end time of the program A is in the vicinity of the recording reserved start time of the program B.

In this case, at a time T6 earlier than the recording reserved end time T9 of the program A (also the recording reserved start time of the program B) by a preset time t3, as shown in FIG. 15(b), the switches 27, 29 of the digital television receiver 11 are changed into the off-state, and the video and audio output terminals 28, 30 are controlled not to output the video and audio signals. Therefore, at and after the time T6, as shown in FIG. 15(c), since the video signal is not supplied, the VTR 13 does not perform the recording operation, and is controlled in the recording stop state.

Subsequently, at a time T7 earlier than the recording reserved start time T9 of the program B by the preset time t1, as shown in FIG. 15(b), the switches 27, 29 of the digital television receiver 11 are changed into the on-state, and the video and audio signals of the record-reserved channel are outputted from the video and audio output terminals 28, 30.

Thereafter, even at a time T8 after the elapse of the predetermined time t2 from the time T7 and before the recording reserved start time T9, as shown in FIG. 15(c), since the video signal is supplied and the synchronous signal is detected, the VTR 13 is controlled in the recording execution state by the input automatic recording function, at the time T9 the stable recording operation state is achieved, and the recorded-reserved program B is recorded.

Moreover, at a recording reserved end time T10 of the program B, as shown in FIG. 15(b), the switches 27, 29 of the digital television receiver 11 are changed to the off-state, and the video and audio output terminals 28, 30 are controlled not to output the video and audio signals. Therefore, at and after the time T10, as shown in FIG. 15(c), since the video signal is not supplied, the VTR 13 does not perform the recording operation, and is controlled in the recording stop state.

When the programs A, B continued in time are respectively record-reserved, first the recording of the program A recorded first is ended at the time T6 earlier than the recording reserved end time T9 by the predetermined time t3. Thereafter, at the time T7 earlier than the recording reserved start time T9 of the program B to be recorded next by the predetermined time t1, the digital television receiver 11 outputs the video and audio signals to record the program B.

That is, when the programs A, B continued in time are recorded by the record reservation, the switches 27, 29 of the digital television receiver 11 are once changed into the off-state, and a period is disposed for which the video and audio output terminals 28, 30 do not output the video and audio signals. Accordingly, the recording apparatus is capable of recognizing and managing the programs A, B as separate files.

That is, the video and audio signals outputted from the MPEG video and audio reproduction circuits 20, 21 are only turned on/off by the switches 27, 29 with a simple control. Therefore, various controls described with reference to FIG. 15 can easily be realized, and this is very suitable for the practical use.

The recording operation in the case where the record reservation is set has been described above. Next, the recording operation in a case where the record reservation is not set. That is, this is an operation in a case where the program being seen/heard now is recorded.

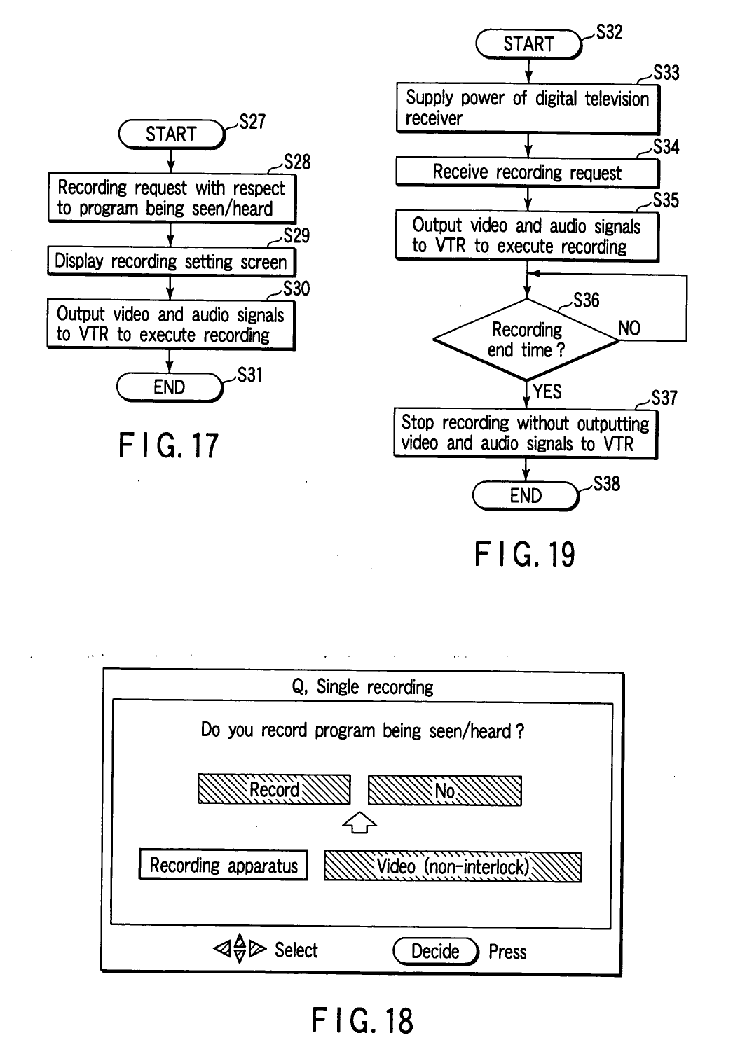

FIG. 17 shows the operation in recording the program being seen/heard in the digital television receiver 11. First, when the process is started (step S27), the user operates the remote controller 31 to request the recording with respect to the program being seen/heard in step S28.

Then, the control circuit 19 allows the CRT 25 to display a recording setting screen in S29. In this recording setting screen, as shown in FIG. 18, the item for selecting whether or not to reserve the recording, the item for designating the apparatus to record, and various items required for the recording are displayed.

Subsequently, when the user operates the remote controller 31 to input the necessary items of the recording setting screen, the control circuit 19 controls the switches 27, 29 in the on-state in S30, and the video and audio signals are supplied to the VTR 13 to execute the recording to end the process (step S31).

It is to be noted that for the recording request by the recording setting screen, the recording is continued for the predetermined time after the recording is requested, and a function of so-called single recording is realized.

FIG. 19 shows the operation in a case where the recording of the program being seen/heard is requested in a state in which the digital television receiver 11 is set to a recording output mode. First, the process is started (step S32), and the user turns on the power of the digital television receiver 11 in step S33.

Then, the control circuit 19 controls each circuit section in the reception state, and the video and audio signals of the received program are supplied to the CRT 25 and speaker 26 and seen/heard.

At this time, when the recording request from the user is not generated, the control circuit 19 controls the switches 27, 29 in the off-state, and does not supply the video and audio signals to the VTR 13 to execute the control so that the recording is prevented from being performed.

On receiving the recording request from the user in this reception state in step S34, the control circuit 19 controls the switches 27, 29 in the on-state in step S35; and supplies the video and audio signals to the VTR 13 to execute the control so that the recording is performed.

In this recording state, the control circuit 19 judges whether or not it is the recording end time in step S36. When it is judged that it is the time (YES), the circuit 19 controls the switches 27, 29 in the off-state, and prevents the video and audio signals from being supplies to the VTR 13 to stop the VTR 13 at step S37. Here, the recording operation with respect to the program being seen/heard is ended (step S38).

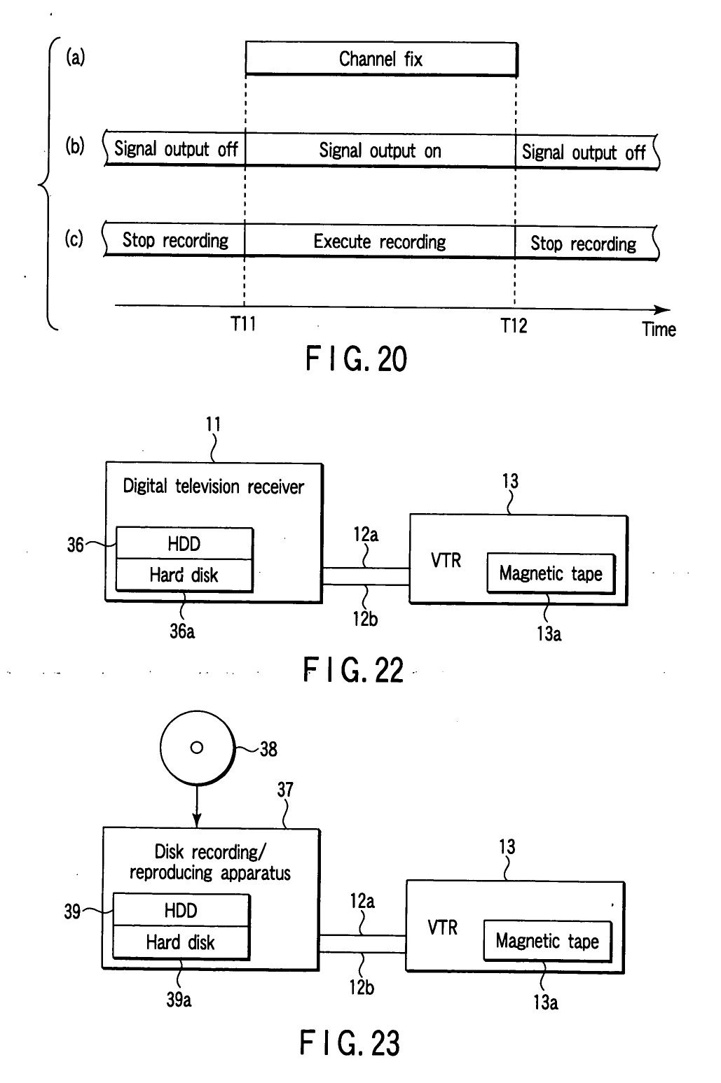

FIG. 20 is a timing chart showing the recording operation on the digital television receiver 11 and that on the VTR 13 by the single recording. In FIG. 20, (a) shows the reception channel, (b) shows the operation of the digital television receiver 11, and (c) shows the operation of the VTR 13.

First, at or before a time T11 when the recording is requested, as shown in FIG. 20(b), the switches 27, 29 of the digital television receiver 11 are changed to the off-state, and the video and audio output terminals 28, 30 are controlled not to output the video and audio signals. Therefore, at or before the time T11, as shown in FIG. 20(c), since the video signal is not supplied, the VTR 13 does not perform the recording operation, and is controlled in the recording stop state.

Subsequently, when the recording is requested at the time T11, as shown in FIG. 20(a), the reception channel is fixed to the channel set immediately before the time T11. As shown in FIG. 20(b), the switches 27, 29 of the digital television receiver 11 are changed into the on-state, and the video and audio signals of the recording-reserved channel are outputted via the video and audio output terminals 28, 30. Therefore, at or after the time T11, as shown in FIG. 20(c), since the video signal is supplied and the synchronous signal is detected, the VTR 13 is controlled in the recording execution state by the input automatic recording function.

Thereafter, at a recording end time T12, as shown in FIG. 20(a), the fixed reception channel is released. As shown in FIG. 20(b), the switches 27, 29 of the digital television receiver 11 is changed into the off-state, and the receiver 11 is controlled in such a manner that the video and audio signals are not. outputted via the video and audio output terminals 28, 30. Therefore, at or after the time T12, as shown in FIG. 20(c), since the video signal is not supplied to the VTR 13, the VTR is controlled in the recording stop state without performing the recording operation.

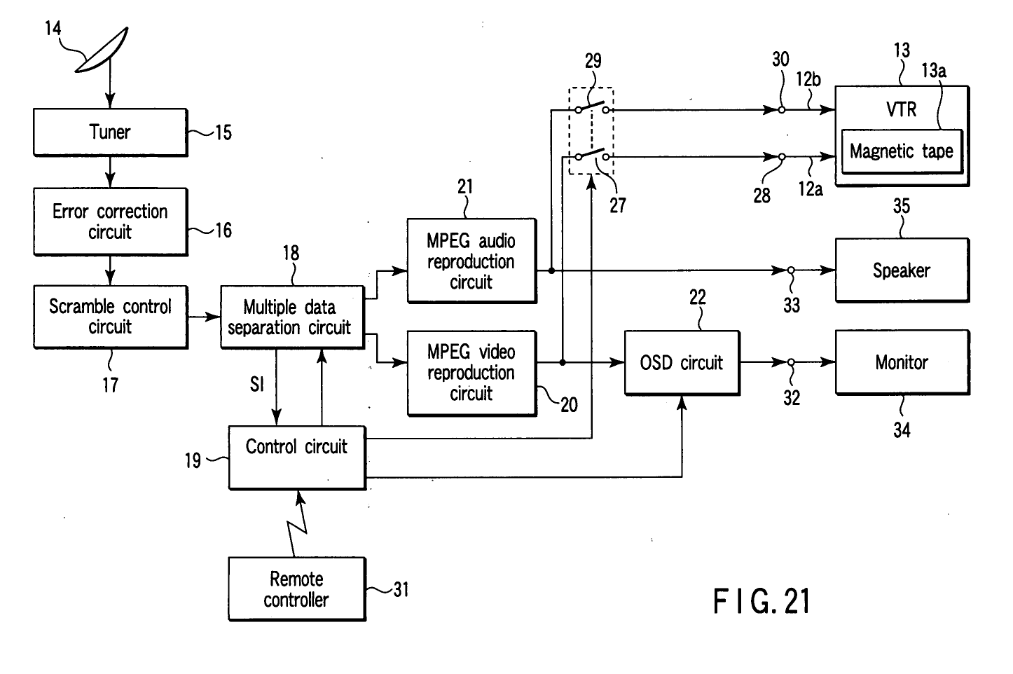

FIGS. 21 to 23 show modifications of the above-described embodiment. First, FIG. 21 shows a modification in which a set top box (STB) is used instead of the digital television receiver 11.

In FIG. 21, the same components as those of FIG. 2 are denoted with the same reference numerals, and the modification will be described. This STB is capable of outputting the video signal outputted from the OSD circuit 22 to the outside via a video output terminal 32 for a monitor. The STB is also capable of outputting the audio signal outputted from the MPEG audio reproduction circuit 21 to the outside via an audio output terminal 33 for the monitor.

Moreover, the video output terminal 32 is connected to a monitor 34, so that the outputted video signal can be video-displayed. The audio output terminal 33 is connected to a speaker 35 so that audio can be reproduced via the outputted audio signal.

Even in this STB, regardless of the outputs of the video and audio signals via the video and audio output terminals 32, 33 for the monitor, only at the recording execution time by the set record reservation, the switches 27, 29 are brought into the on-state, and the analog video and audio signals are outputted to the VTR 13 from the video and audio output terminals 28, 30 so that the recording can be performed.

Moreover, FIG. 22 diagram shows a modification in which the digital television receiver 11 includes a hard disk drive (HDD) 36, and has a function of recording/reproducing the received video and audio signals of the program with respect to a hard disk 36a.

Furthermore, for the digital television receiver 11, the received video and audio signals of the program are outputted to the VTR 13 at the recording execution time so that the recording can be performed. Additionally, the video and audio signals read from the hard disk 36a are also outputted to the VTR 13 so that the recording can be performed at the recording execution time.

It is to be noted that the video and audio signals read from the hard disk 36a at a time other than the recording execution time are not outputted to the VTR 13, but can be supplied for the seeing/hearing via the CRT 25 and speaker 26.

Moreover, FIG. 23 shows a modification in which a disk recording/reproducing device 37 is used instead of the digital television receiver 11. An optical disk 38 such as a rewritable digital versatile disk (DVD) is attached to the disk recording/reproducing device 37. The device 37 records/reproduces the video and audio signals with respect to the optical disk 38.

Furthermore, the disk recording/reproducing device 37 includes an HDD 39, and has a function of recording/reproducing the video and audio signals with respect to a hard disk 39a. The disk recording/reproducing device 37 is also capable of transferring data between the optical disk 38 and the hard disk 39a.

Additionally, the disk recording/reproducing device 37 is capable of outputting the video and audio signals read from the optical disk 38 to the VTR 13 at the recording execution time so that the signals can be recorded. Moreover, the device 37 is also capable of outputting and recording the video and audio signals read from the hard disk 39a into the VTR 13 at the recording execution time.

Moreover, the recording apparatus is not limited to the VTR 13 as long as the apparatus includes the input automatic recording function, and an apparatus using recording mediums such as the disk and semiconductor memory is arbitrarily/selectively usable.

It is to be noted that the present invention is not limited to the above-described embodiment as it is and that constituting elements can variously be modified or embodied without departing from the scope in an implementation stage. Various invention can be formed by an appropriate combination of a plurality of constituting elements described in the above-described embodiment, For example, some constituting elements may also be removed from all the constituting elements described in the embodiment. Furthermore, the constituting elements of different embodiments may also appropriately be combined.

What is claimed is:

1. A video signal output device including a video output terminal which is to be connected to a recording apparatus to output a video signal to the recording apparatus via the video output terminal, the device comprising:
a broadcasting reception unit configured to receive broadcasting;
a record reservation setting unit configured to set record reservation with respect to the broadcasting received by the broadcasting reception unit;
a video signal generation unit configured to produce the video signal from the broadcasting received by the broadcasting reception unit; and
a control unit configured to output the video signal generated by the video signal generation unit to the video output terminal based on a start time of the reserved recording and to stop the output to the video output terminal based on an end time of the reserved recording.

2. A video signal output device according to claim 1, wherein the control unit includes a switch disposed between the video signal generation unit and the video output terminal and constituted to selectively control the video signal generated by the video signal generation unit in a supply state or non-supply state with respect to the video output terminal.

3. A video signal output device according to claim 1, wherein the control unit includes:
a first control unit configured to output the video signal generated by the video signal generation unit to the video output terminal in a state in which an operation of requesting recording start is performed; and
a second control unit configured to stop the video signal generated by the video signal generation unit from being outputted to the video output terminal with an elapse of a predetermined time after the operation of requesting the recording start is performed.

4. A video signal output device according to claim 1, further comprising:
an output terminal configured to output the video signal generated by the video signal generation unit for video display in addition to the video output terminal.

5. A video signal output device according to claim 1, wherein the record reservation setting unit is configured to designate either one of date and program so that record reservation is set.

6. A video signal output device according to claim 1, wherein the control unit is configured to output the video signal generated by the video signal generation unit to the video output terminal at a predetermined time before reaching the start time of the reserved recording and to stop the output to the video output terminal at the end time of the reserved recording.

7. A video signal output device according to claim 6, wherein the control unit is configured to vary the predetermined time.

8. A video signal output device according to claim 1, wherein the control unit is configured in such a manner that a period to stop the video signal generated by the video signal generation unit from being outputted to the video output terminal is disposed between the recording end time based on the record reservation to execute the recording first and the recording start time based on the record reservation to execute the recording later, when a plurality of record reservations are set.

9. A video signal output device according to claim 8, wherein the control unit is configured in such a manner that a period to stop the video signal generated by the video signal generation unit from being outputted to the video output terminal is disposed by advancing the recording end time based on the record reservation to execute the recording first in a case where the recording end time based on the record reservation to execute the recording first agrees with or is close to the recording start time based on the record reservation to execute the recording later.

10. A video signal output device including a video output terminal which is to be connected to a recording apparatus to output a video signal to the recording apparatus via the video output terminal, the device comprising:
a broadcasting reception unit configured to receive broadcasting;
a record reservation setting unit configured to set record reservation with respect to the broadcasting received by the broadcasting reception unit;
a video signal generation unit configured to generate the video signal from the broadcasting received by the broadcasting reception unit;
a control unit configured to output the video signal generated by the video signal generation unit to the video output terminal based on a start time of the reserved recording and to stop the output to the video output terminal based on an end time of the reserved recording; and
a video display unit configured to video-display the video signal generated by the video signal generation unit.

11. A video signal output device according to claim 10, wherein the control unit includes a switch disposed between the video signal generation unit and the video output terminal and constituted to selectively control the video signal generated by the video signal generation unit in a supply state or non-supply state with respect to the video output terminal.

12. A video signal output device according to claim 10, wherein the control unit includes:
a first control unit configured to output the video signal generated by the video signal generation unit to the video output terminal in a state in which an operation of requesting recording start is performed; and
a second control unit configured to stop the video signal generated by the video signal generation unit from being outputted to the video output terminal with an elapse of a predetermined time after the operation of requesting the recording start is performed.

13. A video signal output device according to claim 10, wherein the control unit is configured to output the video signal generated by the video signal generation unit to the video output terminal at a predetermined time before reaching the start time of the reserved recording and to stop the output to the video output terminal at the end time of the reserved recording.

14. A video signal output device according to claim 13, wherein the control unit is configured to vary the predetermined time.

15. A video signal output device according to claim 10, wherein the control unit is configured in such a manner that a period to stop the video signal generated by the video signal generation unit from being outputted to the video output terminal is disposed between the recording end time based on the record reservation to execute the recording first and the recording start time based on the record reservation to execute the recording later, when a plurality of record reservations are set.

16. A video signal output device according to claim 8, wherein the control unit is configured in such a manner that a period to stop the video signal generated by the video signal generation unit from being outputted to the video output terminal is disposed by advancing the recording end time based on the record reservation to execute the recording first in a case where the recording end time based on the record reservation to execute the recording first agrees with or is close to the recording start time based on the record reservation to execute the recording later.

17. A video signal output method in which a video signal is outputted to a recording apparatus via a video output terminal, comprising:
receiving broadcasting;
setting record reservation with respect to the received broadcasting;
generating the video signal from the received broadcasting; and
outputting the generated video signal to the video output terminal based on a start time of the reserved recording and stopping the output to the video output terminal based on an end time of the reserved recording.

18. A video signal output method according to claim 17, further comprising:
outputting the video signal generated from the received broadcasting to the video output terminal in a state in which an operation of requesting recording start is performed; and
stop the generated video signal from being outputted to the video output terminal with an elapse of a predetermined time after the operation of requesting the recording start is performed.
